(19) United States
(12) Patent Application Publication
(10) Pub. No.: US 2018/0108084 A1
(43) Pub. Date: Apr. 19, 2018

(54) AUTOMATED COGNITIVE PSYCHOMETRIC SCORING

(71) Applicant: International Business Machines Corporation, Armonk, NY (US)

(72) Inventors: Francisco M. Gomez Sanchez, Cordoba (AR); Pablo R. Najimovich, Buenos Aires (AR); Pablo J. Pedemonte, Buenos Aires (AR); Hernan Pepe Petersen, Buenos Aires (AR)

(21) Appl. No.: 15/294,706

(22) Filed: Oct. 15, 2016

(51) Int. Cl. G06Q 40/02; G06Q 50/00; G06N 99/00

(52) U.S. Cl. CPC G06Q 40/025; G06N 99/005; G06Q 50/01

(57) ABSTRACT

A computer-implemented method for automated psychometric scoring which includes: collecting applicant data pertaining to an application from an applicant, the data including the applicant's name, age and demographic information; collecting textual information posted by the applicant from social media; automatically obtaining a personality profile of the applicant computed from the textual information; building a consolidated applicant profile by joining the personality profile and the applicant data; inputting the consolidated applicant profile into a machine learning model to compute an approval score with respect to approving or not approving the application; and outputting the approval score from the machine learning model.

### BACKGROUND

The present exemplary embodiments pertain to a method of psychometric scoring of applicants from psychological traits and, more particularly, relate to an automated method of psychometric scoring in which a model based on prior applicants is utilized to predict psychometric scores of future applicants.

Risk assessment is a key activity for financial institutions. Lenders such as banks or credit card companies rely on a credit score, based on a level analysis of an individual's credit history, to determine the risk of lending money to an individual and mitigate losses derived from unpaid loans. There is an emerging trend towards exploiting correlations between personality traits and credit scoring to develop personality-based scoring systems. This emerging trend is driven by the need to provide access to credit to people lacking a credit history. Typically, people lacking a credit history may include unbanked people (people without bank accounts) from underdeveloped countries and individuals belonging to informal economy sectors in emerging/developed countries.

### BRIEF SUMMARY

The various advantages and purposes of the exemplary embodiments as described above and hereafter are achieved by providing, according to an aspect of the exemplary embodiments, a computer-implemented method for automated psychometric scoring comprising: collecting applicant data pertaining to an application from an applicant, the data including the applicant's name, age and demographic information; collecting textual information posted by the applicant from social media; automatically obtaining a personality profile of the applicant computed from the textual information; building a consolidated applicant profile by joining the personality profile and the applicant data; inputting the consolidated applicant profile into a machine learning model to compute an approval score with respect to approving or not approving the application; and outputting the approval score from the machine learning model.

According to another aspect of the exemplary embodiments, there is provided a computer program product for automated psychometric scoring, the computer program product comprising a computer readable storage medium having program instructions embodied therewith, the program instructions executable by a processor to cause the processor to perform a method comprising: collecting applicant data pertaining to an application from an applicant, the data including the applicant's name, age and demographic information; collecting textual information posted by the applicant from social media; automatically obtaining a personality profile of the applicant computed from the textual information; building a consolidated applicant profile by joining the personality profile and the applicant data; inputting the consolidated applicant profile into a machine learning model to compute an approval score with respect to approving or not approving the application; and outputting the approval score from the machine learning model.

According to a further aspect of the exemplary embodiments, there is provided a system for automated psychometric scoring: at least one non-transitory storage medium that store instructions; and at least one processor that executes the instructions to: collect applicant data pertaining to an application from an applicant, the data including the applicant's name, age and demographic information; collect textual information posted by the applicant from social media; automatically obtain a personality profile of the applicant computed from the textual information; build a consolidated applicant profile by joining the personality profile and the applicant data; input the consolidated applicant profile into a machine learning model to compute an approval score with respect to approving or not approving the application; and output the approval score from the machine learning model.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a flow chart illustrating a process flow of the exemplary embodiments which may employ a machine learning model generator based on a logistic regression model and an application analyzer.

FIG. 2 is a flow chart illustrating further details of the machine learning model generator.

FIG. 3 is a flow chart illustrating further details of the application analyzer.

FIG. 4 is an illustration of a consolidated profile for an applicant.

### DETAILED DESCRIPTION

The current systems for personality-based credit scoring require applicants to complete a questionnaire form which may be subsequently analyzed by domain experts or automatically by some system. But this process has weaknesses.

A first weakness is that the current systems are not fully automated in that applicants must manually fill in the evaluation forms.

A second weakness is that applicants might manipulate answers to try to cheat the evaluators or the evaluation systems and inflate their credit scores.

A third weakness is that a manual approach to create sound user models that predict credit scores from psychological traits is impractical and time-consuming. To correctly predict credit scores from psychological traits, a system needs a model that correlates both credit scores and psychological traits. This kind of model is constructed from training data obtained from old credit applications, namely, the psychological profile of the applicant and the known credit score. But, for this to be effective, the analysis must be done on a very large scale, typically thousands or tens of thousands of old applications would have to be processed, meaning that a company would need to retroactively get the psychometric information of thousands of clients manually. This approach does not scale well and is sensitive to privacy issues.

The exemplary embodiments aim to circumvent such limitations of current systems by proposing a fully automated way to perform the psychometric evaluation of existing and future credit applicants.

Although the exemplary embodiments are explained in a financial setting for sake of presentation, the exemplary embodiments are not necessarily financial specific to applications such as credit applicants. The exemplary embodiments are readily applicable to other exemplary embodiments where decisions may be made based on personality traits, such as applications for life insurance or automobile insurance.

There is proposed in the exemplary embodiments a cognitive method for assessing applications, such as credit and loan applications, based on personality traits and basic applicant data such as age and demographics information. Personality traits may be computed by a fully automated process collecting an applicant's public domain social data and passing that data to a personality service such as the Watson Personality Insights (WPI) service (IBM Corporation), PROFILE (Hello Soda), Juji or Receptiviti to automatically obtain a personality profile. These personality services are so-called Big Data analytics tools that may use the Big Five personality traits (openness to experience, conscientiousness, extraversion, agreeableness, and neuroticism) to generate a personality score. The Big-Five personality model is the most common one, so all these personality services are based on such model to a larger or lesser extent. Some of these services (such as Personality Insights and Receptiviti) may return Big-Five personality traits directly while other personality services may use such traits to give an enriched personality profile including aspects like thinking style, working style, social styles, or interests and orientations. Other personality services, such as Broad Listening, may use a different model such as the Myers-Briggs type indicator model.

While a personality service using just the Big-Five personality traits model is preferred for the exemplary embodiments, it should be understood that the other personality services may be used for the exemplary embodiments.

The foregoing information is then processed by a statistical machine learning component and finally emitting an approval score for the applicant. The approval score may indicate, for example, that the approval score is below a threshold value and thus the applicant may be denied or alternatively, the approval score may exceed a threshold and thus the applicant may be approved. The machine learning component works on a model trained with personality profiles automatically synthesized from historical credit applications by means of the personality service.

By replacing questionnaire forms with an automated process collecting public domain social data and feeding it to the personality service to compute personality traits, the exemplary embodiments have the following advantages:

The exemplary embodiments are fully automatic;

The exemplary embodiments may only ingest public content produced by applicants on social networks;

The chances of applicants manipulating their entire online social activity to beat the scoring system are slim; and

Creating statistically sound user models predicting credit scores from psychological traits can be done automatically, since personality traits may be computed from existing applicants seamlessly.

The exemplary embodiments may be provided as a stand-alone product or as a service deployed at a financial organization. The applicant's information, such as name, email, age, and demographic information, from the application, such as a credit application, may be collected. Then the exemplary embodiments may collect social contents produced or posted by the applicant. These social contents may be from, for example, Twitter, Facebook, Instagram, and would invoke the personality service to obtain the applicant's personality profile. The applicant's information and the personality profile may be fed to a statistical machine learning component which in turn may output an approval score. Such approval score may be used to make a decision regarding the approving or not approving the applicant's application. Optionally, the application information including applicant's personality profile and approval score may be fed back to the machine learning component in an iterative process so that the approval scoring may be improved over time.

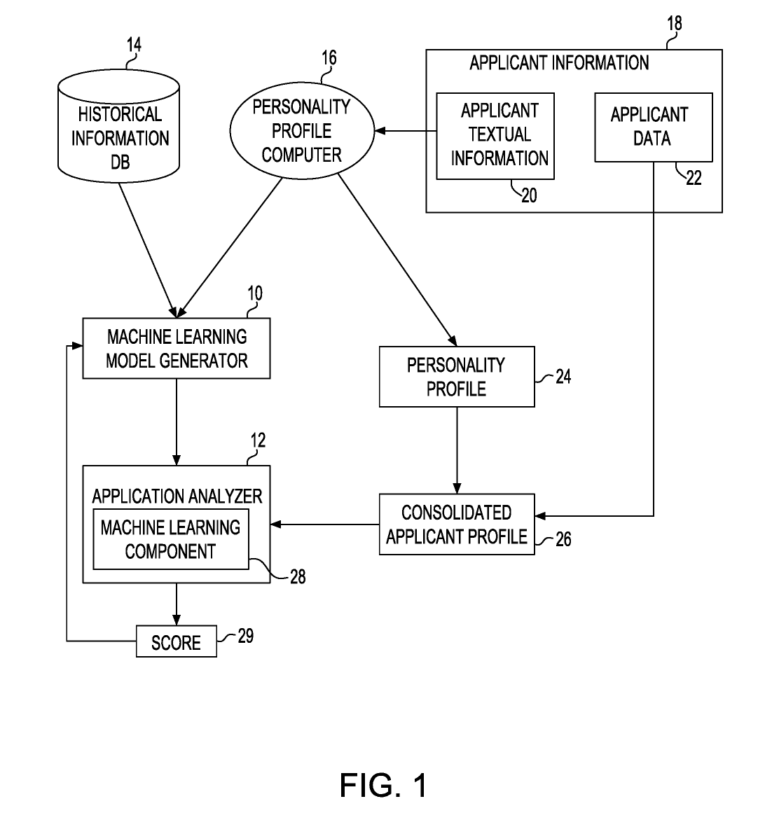

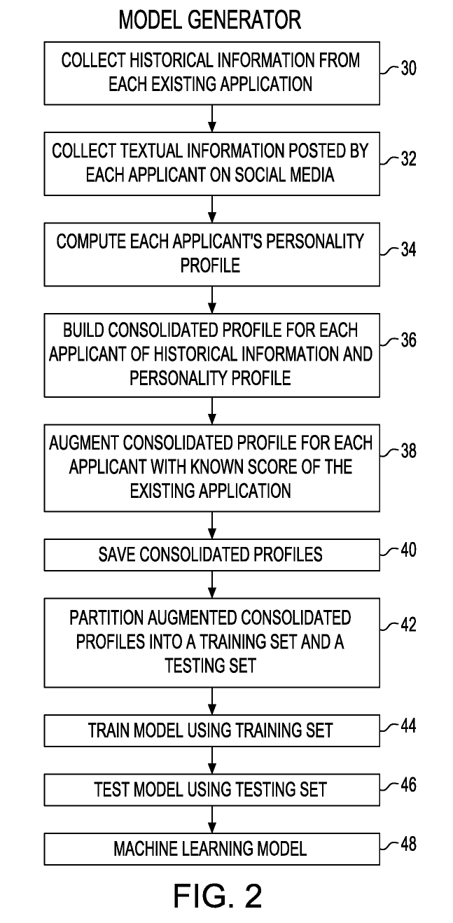

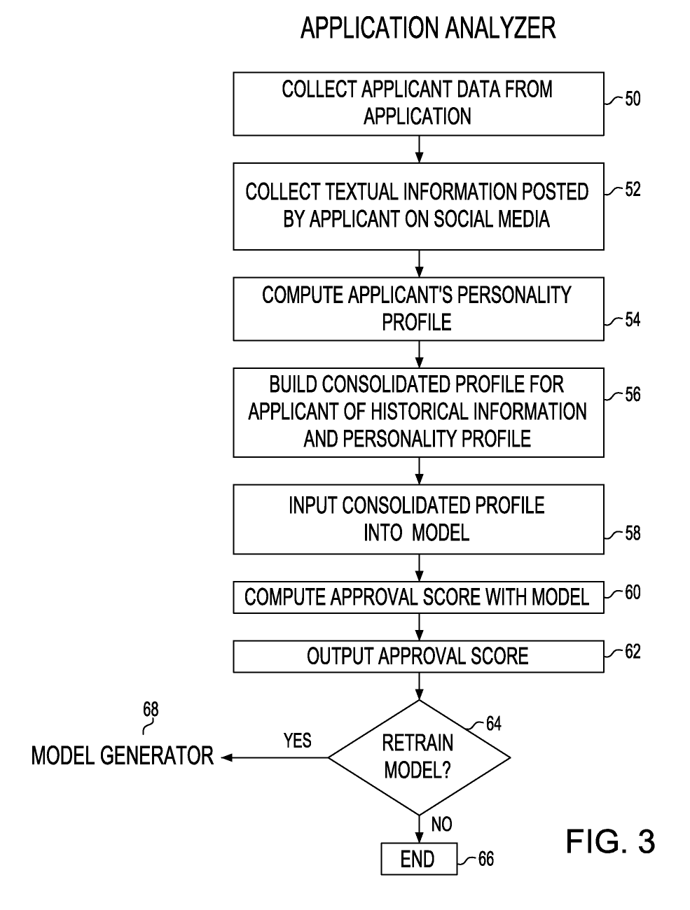

Referring to the drawings in more detail, FIG. 1 is a flow chart illustrating a process flow of the exemplary embodiments which may employ a machine learning model generator 10 based on a logistic regression model and an application analyzer 12. Further details of the machine learning model generator 10 are illustrated in the flow chart in FIG. 2 and further details of the application analyzer 12 are illustrated in the flow chart in FIG. 3. In the following description, FIGS. 1 to 3 will be referred to.

The machine learning model generator 10 will be discussed first with reference to FIGS. 1 and 2.

The machine learning model generator 10 (FIG. 1) builds the model used by the machine learning component 28 (FIG. 1) in the application analyzer 12 (FIG. 1). The model would be of the logistic regression type, and it is created from historical applications stored in historical information 14 (FIG. 1) according to the following process.

Historical information for each existing application is collected and stored in historical information database 14 (FIG. 1) and step 30 in FIG. 2.This historical information may include applicant data such as name, age and demographic information.

Demographic information refers to any further information besides name and age that a credit scoring firm might obtain from applicants. Such information may vary depending on factors such as country privacy laws and the kind of loan. For purposes of illustration and not limitation, demographic information may further include information such as address of applicant, education level of applicant, marital status of applicant and number of children, current work position, work history, current income and income history.

Textual information produced by each applicant such as information posted to the applicant's twitter feed, Facebook, Instagram and other social media, step 32 in FIG. 2. Such textual information includes current postings by the applicants as well as older postings that may exist on the Internet. The textual information is not part of the historical information nor is it stored at any stage in the historical information database.

Each applicant's textual information is inputted to a personality service computer 16 and the applicant's personality profile is computed, step 34 in FIG. 2.

A consolidated applicant profile is built for each existing applicant, step 36 in FIG. 2, joining the applicant data previously collected in step 30 in FIG. 2 and the components of the personality profile computed in step 34 in FIG. 2.

The historical information refers to archived (historical; approved or rejected) applications before adopting a cognitive approach. The historical information may comprise whatever information the company has about applicants (for example, age, address, marital status, etc.), but not the textual information produced by applicants. As this historical information is processed in order to train and test a logistic classifier, it will be enriched with the personality profile of the applicants, thus building a consolidated applicant profile. For the personality profile, the applicant's textual data is fed to the personality service. So the textual information is downloaded on demand and not stored on the historical information database 14.

Since the model generator is dealing with existing applications, these existing applications may already have an approval score. Accordingly, the consolidated profile for each existing applicant may be augmented with the known approval score of the existing application, step 38 in FIG. 2.

The consolidated profile and the augmented consolidated profile for each existing applicant may be stored in a database, preferably a database other than the historical information database 14, step 40 in FIG. 2.

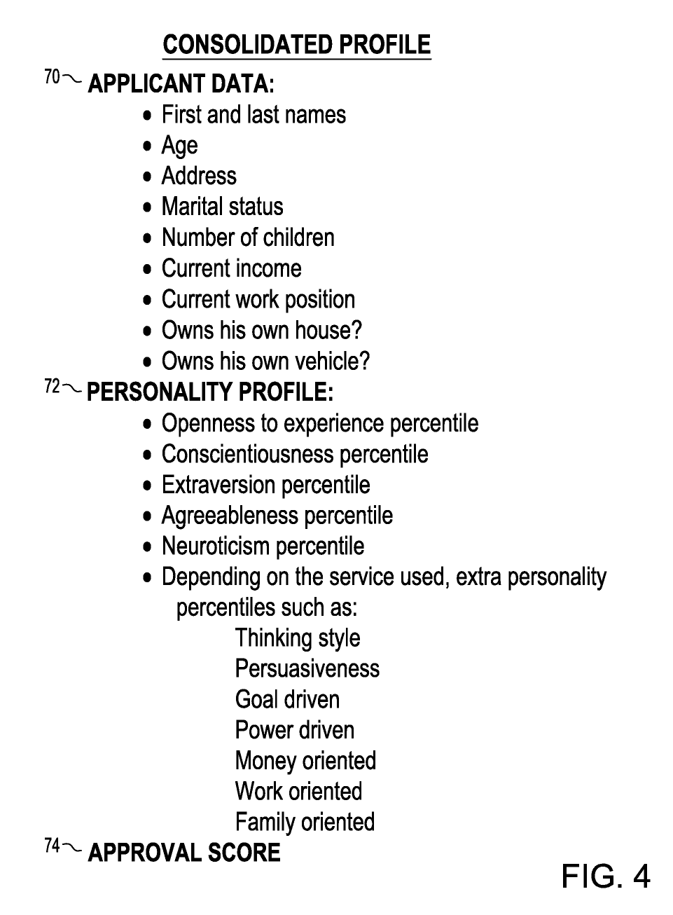

A consolidated profile for an applicant is illustrated in FIG. 4. The consolidated profile may include applicant data 70 and the computed personality profile 72 from the personality service. The consolidated profile may further include the approval score 74 obtained from historical application data. When the consolidated profile contains the approval score 74, the consolidated profile becomes an augmented consolidated profile. The use of the approval score 74 in the augmented consolidated profile is only for training and testing consolidated profiles built from historical application data. For new applications, the approval score 74 is a value to be computed for the applicant.

The augmented consolidated profiles for the existing applicants may be partitioned into two sets, step 42 in FIG. 2. One set may be for training of the model generator and the other set may be for testing of the model generator. For purposes of illustration and not limitation, the training set may use about 75% of the augmented consolidated profiles for training and about 25% of the augmented consolidated profiles for testing.

A logistic regression model may be trained on the training set of the augmented consolidated profiles for the existing applicants using, for example, support vector machines, bayesian logistic regression, or conditional random fields, step 44 in FIG. 2.

The logistic regression model from step 44 in FIG. 2 may be tested using the testing set of the augmented consolidated profiles for the existing applicants using a standard measure of a test's accuracy such as the F1 score. If the approval score is too low, adjust training parameters (like regularization) and repeat the training.

The result of the process steps outlined in FIG. 2 is a machine learning model, step 48 in FIG. 2.

The application analyzer is discussed with reference to FIGS. 1 and 3.

An applicant's information 18 (FIG. 1) for a given application is collected. The applicant's information may include the applicant data 22 (FIG. 1) such as name, email, age, demographic information and may be collected from the application, step 50 in FIG. 3. The applicant information may further include textual information 20 (FIG. 1) that is posted by the applicant on social media, step 52 in FIG. 3. This textual information 20 may include, for example, the applicant's twitter feed and information posted by the applicant on Facebook, Instagram and other social media.

The applicant's personality profile 24 (FIG. 1) may be computed by personality profile computer 16 (FIG. 1) from the applicant textual information 20 (FIG. 1), step 54 in FIG. 3.

A consolidated applicant profile 26 (FIG. 1) is built joining the applicant data 22 (FIG. 1) and the personality profile 24 (FIG. 1), step 56 in FIG. 3.

The machine learning component 28 (FIG. 1) in the application analyzer 12 (FIG. 1) using the machine learning model 10 (FIG. 1) is invoked by inputting the consolidated applicant profile 26 (FIG. 1), step 58 in FIG. 3. The machine learning component 28 (FIG. 1) will compute the approval score (step 60 in FIG. 3). A positive value of the approval score may indicate that the application was accepted while a negative value of the approval score may indicate that the application was rejected. The larger the absolute value of the score, the stronger the confidence in the result.

The approval score 29 (FIG. 1) may be outputted for use by interested parties, step 62 in FIG. 3.

It may be necessary or desirable to continually retrain the machine learning component 28 (FIG. 1) and hence also the machine learning model generator 10 (FIG. 1). As denoted by decision block 64 in FIG. 3, a decision may be made whether to retrain or not. Retraining may be done as a matter of course just to keep the machine model generator up to date. Alternatively, retraining may be advisable if an absolute value of the approval score exceeds a configurable threshold.

If the approval score is deemed within tolerance and no retraining is necessary or desirable, the “NO” path is followed and the application analyzer process ends, step 66 in FIG. 3.

If retraining is desirable or necessary, then the “YES” path is followed to retrain the model generator, step 68 in FIG. 3.

Retraining may be accomplished by the following process. The consolidated profile for the present application previously built in step 56 in FIG. 3 is augmented with the computed approval score obtained in step 60 in FIG. 3. This augmented consolidated profile is then added to the augmented consolidated profiles for the existing applications (step 38 in FIG. 2). The model generator may then be retrained using this new combined set of augmented consolidated profiles.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A computer-implemented method for automated psychometric scoring comprising:
collecting applicant data pertaining to an application from an applicant, the data including the applicant's name, age and demographic information;
collecting textual information posted by the applicant from social media;
automatically obtaining a personality profile of the applicant computed from the textual information;
building a consolidated applicant profile by joining the personality profile and the applicant data;
inputting the consolidated applicant profile into a machine learning model to compute an approval score with respect to approving or not approving the application; and
outputting the approval score from the machine learning model.

2. The method of claim 1 further comprising generating the machine learning model comprising:
collecting historical information for a plurality of existing applicants of existing applications including applicant data from each of the plurality of existing applicants;
collecting textual information posted by each of the plurality of existing applicants from social media;
computing a personality profile of each of the plurality of existing applicants from the textual information from each of the plurality of existing applicants;
building a consolidated applicant profile for each of the plurality of existing applicants by joining the personality profile and the applicant data for each of the plurality of existing applicants; and
training the machine learning model based on a logistic regression model of the existing applications using the consolidated applicant profile for each of the plurality of existing applicants to compute an approval score related to the existing applications with respect to approving or not approving the applications.

3. The method of claim 2 further comprising testing the machine learning model using at least some of the consolidated applicant profiles of the plurality of existing applicants.

4. The method of claim 2 wherein after building the consolidated applicant profile for each of the plurality of existing applicants further comprising augmenting the consolidated profiles of the plurality of existing applicants with a known score on the existing application for each of the plurality of existing applicants.

5. The method of claim 1 wherein the personality profile includes the big five personality traits of openness to experience, conscientiousness, extraversion, agreeableness, and neuroticism.

6. The method of claim 1 further comprising inputting the approval score back into the machine learning model to retrain the machine learning model.

7. The method of claim 6 wherein inputting the approval score back into the machine learning model includes augmenting the building a consolidated applicant profile of the applicant with the approval score to result in an augmented consolidated profile of the applicant, adding the augmented consolidated applicant profile to the machine learning model and retraining the machine learning model based on the logistic regression model using the consolidated applicant profile for each of the plurality of existing applicants and the augmented consolidated profile of the applicant.

8. A computer program product for automated psychometric scoring, the computer program product comprising a computer readable storage medium having program instructions embodied therewith, the program instructions executable by a processor to cause the processor to perform a method comprising:
collecting applicant data pertaining to an application from an applicant, the data including the applicant's name, age and demographic information;
collecting textual information posted by the applicant from social media;
automatically obtaining a personality profile of the applicant computed from the textual information;
building a consolidated applicant profile by joining the personality profile and the applicant data;
inputting the consolidated applicant profile into a machine learning model to compute an approval score with respect to approving or not approving the application; and
outputting the approval score from the machine learning model.

9. The computer program product of claim 8 further comprising generating the machine learning model comprising:
collecting historical information for a plurality of existing applicants of existing applications including applicant data from each of the plurality of existing applicants;
collecting textual information posted by each of the plurality of existing applicants from social media;
computing a personality profile of each of the plurality of existing applicants from the textual information from each of the plurality of existing applicants;
building a consolidated applicant profile for each of the plurality of existing applicants by joining the personality profile and the applicant data for each of the plurality of existing applicants; and
training the machine learning model based on a logistic regression model of the existing applications using the consolidated applicant profile for each of the plurality of existing applicants to compute an approval score related to the existing applications with respect to approving or not approving the applications.

10. The computer program product of claim 9 further comprising testing the machine learning model using at least some of the consolidated applicant profiles of the plurality of existing applicants.

11. The computer program product of claim 9 wherein after building the consolidated applicant profile for each of the plurality of existing applicants further comprising augmenting the consolidated profiles of the plurality of existing applicants with a known score on the existing application for each of the plurality of existing applicants.

12. The computer program product of claim 8 wherein the personality profile includes the big five personality traits of openness to experience, conscientiousness, extraversion, agreeableness, and neuroticism.

13. The computer program product of claim 8 further comprising inputting the approval score back into the machine learning model to retrain the machine learning model.

14. The computer program product of claim 13 wherein inputting the approval score back into the machine learning model includes augmenting the building a consolidated applicant profile of the applicant with the approval score to result in an augmented consolidated profile of the applicant, adding the augmented consolidated applicant profile to the machine learning model and retraining the machine learning model based on the logistic regression model using the consolidated applicant profile for each of the plurality of existing applicants and the augmented consolidated profile of the applicant.

15. A system for automated psychometric scoring:
at least one non-transitory storage medium that store instructions; and
at least one processor that executes the instructions to:
collect applicant data pertaining to an application from an applicant, the data including the applicant's name, age and demographic information;
collect textual information posted by the applicant from social media;
automatically obtain a personality profile of the applicant computed from the textual information;
build a consolidated applicant profile by joining the personality profile and the applicant data;
input the consolidated applicant profile into a machine learning model to compute an approval score with respect to approving or not approving the application; and
output the approval score from the machine learning model.

16. The system of claim 15 further comprising generate the machine learning model comprising:
collect historical information for a plurality of existing applicants of existing applications including applicant data from each of the plurality of existing applicants;
collect textual information posted by each of the plurality of existing applicants from social media;
obtain a personality profile of each of the plurality of existing applicants computed from the textual information from each of the plurality of existing applicants;
build a consolidated applicant profile for each of the plurality of existing applicants by joining the personality profile and the applicant data for each of the plurality of existing applicants; and
train the machine learning model based on a logistic regression model of the existing applications using the consolidated applicant profile for each of the plurality of existing applicants to compute an approval score related to the existing applications with respect to approving or not approving the applications.

17. The system of claim 16 wherein after building the consolidated applicant profile for each of the plurality of existing applicants further comprising augment the consolidated profiles of the plurality of existing applicants with a known score on the existing application for each of the plurality of existing applicants.

18. The system of claim 15 wherein the personality profile includes the big five personality traits of openness to experience, conscientiousness, extraversion, agreeableness, and neuroticism.

19. The system of claim 15 further comprising input the approval score back into the machine learning model to retrain the machine learning model.

20. The system of claim 19 wherein input the approval score back into the machine learning model includes augment the build a consolidated applicant profile of the applicant with the approval score to result in an augmented consolidated profile of the applicant, add the augmented consolidated applicant profile to the machine learning model and retrain the machine learning model based on the logistic regression model using the consolidated applicant profile for each of the plurality of existing applicants and the augmented consolidated profile of the applicant.
